(19) United States
(12) Patent Application Publication
(10) Pub. No.: US 2002/0082874 A1
(43) Pub. Date: Jun. 27, 2002

(54) Electronic procurement system and method for trading and exchange by insurers, reinsurers and brokers of risks and capacities

(75) Inventor: Rosanna L. Go, Makati City (PH)

Correspondence Address: OSTROLENK FABER GERB & SOFFEN, 1180 AVENUE OF THE AMERICAS, NEW YORK, NY, 100368403

(73) Assignee: Re2Re.com Limited, Incorporated

(21) Appl. No.: 10/005,303

(22) Filed: Nov. 12, 2001

Related U.S. Application Data
(60) Provisional application No. 60/252,616, filed on Nov. 22, 2000.

(51) Int. Cl. G06F 17/60

(52) U.S. Cl. 705/4

(57) ABSTRACT

A system and method for facilitating the insurance of risk and reinsurance transactions. The system accepts a cession from a first user, posts the cession on a host computer system, receives from the first user an identification of at least one second user designated to receive the cession, provides the at least one second user with access to cession on to the host computer system, and receives a response from the at least one second user. The response includes one of a declination of the cession, an acceptance of the cession, and a request for additional information about the cession. The system allows the cedant to execute the cession if the response from the at least one second user is the acceptance of the cession.

### FIELD OF THE INVENTION

The invention generally relates to a system and method for providing insurance and more specifically to a system and method for facilitating reinsurance contracts.

### BACKGROUND OF THE INVENTION

In 1999, the size of the global market for non-life insurance was approximately $750 billion. Reinsurance and insurance transactions typically are executed on a global basis. The reinsurance and insurance market is fragmented and has many intermediaries, buyers and sellers of risks and capacities that, even though the industry has regional hubs which operate as transaction aggregators, the path from underwriting and placing a risk to reinsuring that risk can be extremely complex, time consuming and expensive.

FIG. 1 shows a typical present day transaction flow of a facultative offer as initiated by a direct insurer. The process of reinsuring a risk typically begins when a person or organization (requester, R) calls a number, all or a mix of other direct insurers (for co-insurance support), reinsurers, or a reinsurance broker to request for reinsurance support (step 1). This group is often referred to as a panel I. A reinsurer is an insurance carrier that insures other insurance carriers against risks the insurer has assumed. Reinsurance is typically used to spread the risk originally assumed by the insurer. The greater the sum insured of the risk, the greater the number of reinsurers or members in a panel is needed to fully allocate the risk.

The co-insurers, reinsurance broker and/or reinsurers I work with the requestor R to clarify the details of the risk which the requester R desires to reinsure. With the information provided by the requestor R, the parties in the panel I evaluate the terms and conditions offered by the requester R and/or offer their own terms and conditions by which they would accept a share of the risk for reinsurance coverage. This process may require many exchanges between the requestor R and the panel I before final terms are acceptable to all parties. Each exchange or communication of information by the requestor R can be done individually by telephone, facsimile, e-mail or other conventional communication means, to the panel I previously selected (step 2).

Once received, each member of the panel I evaluates the offer transmitted from the requester R. One or more members of the panel I can immediately decide to either accept or decline the offer, but typically the panel members I contact the requestor R to request more information regarding the offer before accepting or declining (step 3). In step 4, following a request for information, the panel member I usually re-contacts the requester R to obtain the necessary additional information regarding the offer, if available. Following information collection from either and/or the client and broker, the requestor R passes the information on to the information-requesting panel member I.

In step 5, the panel members I express acceptance or declination of the cession. If panel members I accept the offer, the ceding party (broker B or requester R) gathers the acceptances from the panel members I by requesting for their acceptance codes and prepares provisional binders pertaining to the terms and conditions of the risk ceded. In step 6, the requestor R supplies each accepting panel member I with a provisional binder reciting the particularities of the risk ceded. These provisional binders are typically manually generated and often mailed or faxed to the panel members I 60-90 days after the transaction was concluded as they need to be encoded and processed by the respective panel members' I company back rooms.

Historically, the process illustrated in FIG. 3 requires days if not weeks to complete. Delays are often quite frequent when the requesters R are required to locate and provide the panel members I with sufficient information, more days for the panel members I to consider the information, and still more days for the insurers to re-contact the reinsurers and/or reinsurance brokers and communicate acceptance or declination. The mere transmittal of the various papers associated with the process shown in FIG. 3 can consume days. As time spent coordinating the placement and reinsurance of risk translates into money, the current process also is unnecessarily costly.

One of the prime reasons that the current one-to-one process suffers significant time lags is due to communication gaps among parties. Also, various events which should occur upon the occurrence of other events, such as generation of a provisional binder upon acceptance, do not happen automatically. Further, the current process is shackled with time-consuming, labor-intensive events, such as creating and transmitting offers, and creating and delivering provisional binders related to accepted offers to appropriate parties.

In order to streamline the procurement process, more sophisticated insurance models have been considered and implemented with limited success. For example, some more forward direct insurers and reinsurers have tried a one-to-many exchange process. For the direct insurer that has established a one-to-many site, his site does not provide the breadth of choice that cedants require when searching for insurers to underwrite their clients' risks. In effect, such one-to-many sites simply operate as a one-way electronic mail facility and ultimately suffer from inherent “channel conflict.” Other one-to-many sites currently in the market today also only offer “market specific” or “product specific” coverages. These coverages relate mostly to “commoditized” perils such as catastrophe covers and are North America-centric. There currently exists no truly neutral and open market place for insurers and reinsurers on a global basis.

### SUMMARY OF THE INVENTION

The present invention overcomes the problems of the prior art by providing an electronic commerce system for automating transactions among direct insurers, insurance brokers, reinsurers and reinsurance brokers with a platform for conducting real-time, Internet-based trading of risks and reinsurance capacities.

The electronic procurement system of the present invention allows users to trade, exchange, initiate and consummate insurance, co-insurance, reinsurance and retrocession transactions. The user are typically insurers, insurance brokers, reinsurers and reinsurance brokers. The system is a market place that aggregates buyers, sellers and intermediaries at a common, virtual information exchange. The system provides a market place that promotes cost and scale efficiency in a true many-to-many exchanges.

In the preferred embodiment, the system is implemented as a Internet website enabled by one or more servers. The users are required to register themselves as members, after which they can log onto the system in a secure manner. The system allows a cedant to develop and post a cession and then allows the cedant to select the other members that it wishes to respond to the cession. As the members log onto the system, they are informed of the cessions that they have been selected to evaluate. Alternatively, the system provides the members with an e-mail notification informing them that a cession is awaiting their evaluation. If the receiving member has any questions concerning the cession, the question is immediately and directly forwarded to the cedant by private email/chat facility and the cedant can immediately respond either with the requested information or perhaps with a change to the cession.

The system logs all of the recipient's responses to the cession such as acceptance or declination and forwards the responses to the cedant. If sufficient members of the parties have agreed to the cession, and the cedant executes the cession, the system automatically generates the required binders and forwards them to the accepting parties.

The system includes groupware applications for facilitating collaborative efforts between the members of the exchange, typically insurance-related businesses. The system includes content that provides members with market and business intelligence to promote informed decision making.

Interaction costs are reduced by the system as it reduces the time and effort searching for appropriate insuring and reinsuring parties and for qualifying of a risk for parties selected. Costs are further reduced since the system employs inexpensive, fast and convenient transaction communications. Over time, it is envisioned that intermediary costs will be reduced through lowering reinsurance and broker commissions, as a consequence of the reduced interaction cost. The system increases market efficiencies by providing greater access to market capacities.

Other features and advantages of the present invention will become apparent from the following description of the invention which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 illustrates the insurance or re-insurance process of the prior art;

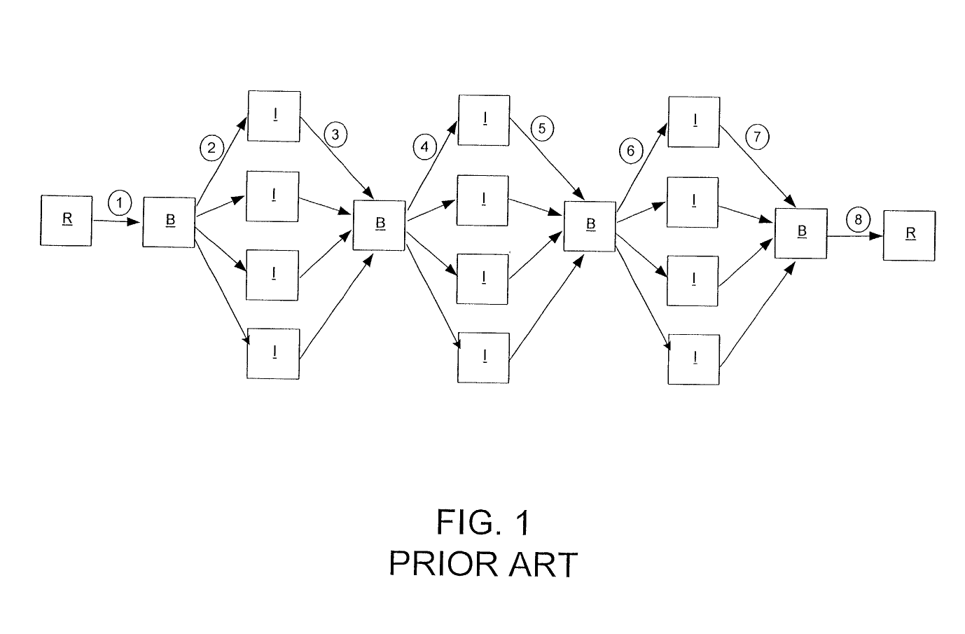

FIG. 2 shows the system of the present invention; and

FIG. 3 is a flow chart illustrating the method of the present invention.

### DETAILED DESCRIPTION OF THE PREFERRED EMBODIMENTS

The present invention is a system and a method for automating transactions among direct insurers, insurance brokers, reinsurers and reinsurance brokers. The system includes a platform for conducting real-time, Internet-based trading of risks and reinsurance capacities.

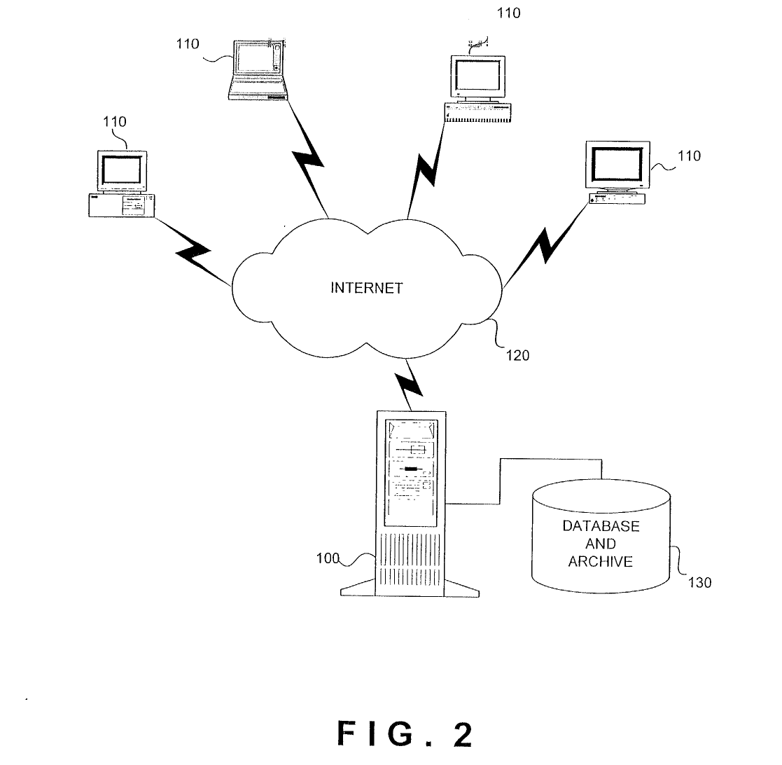

The physical elements for carrying out the invention are well known. FIG. 2 shows the generalized structural components of the present invention. Host computer 100 is linked with a plurality of anticipated users 110 that access the host computer 100 through a computer network 120. In the preferred embodiment, the network 120 is the Internet, but can also be other networks such as a private Value Added Network (VAN). Alternatively, the users 110 can access the host computer using leased lines such as a T1 line. The present invention does not rely on the particular means by the users 110 connect to the host computer. The Internet is the preferred network 120 for connecting to host computer as it has become ubiquitous throughout the world.

In the preferred Internet embodiment, the host computer 100 hosts a web site, a collection of text and image data and executable program data stored in an indexed database 130, which is accessible by the users 110 through the Internet. The web site hosted by computer 100 has a conventional Internet address which permits users 110 accessing the Internet to locate the web site and view and/or execute programs associated therewith. Although only a single computer 100 has been illustrated as comprising host 100, it is appreciated by those skilled in the art that host 100 can be enabled by one or more computers and storage devices acting as data and application servers.

The users 110 access the Internet typically with a personal computer electronically connected by telephone, or other conventional Internet connectors, to an Internet service provider (not shown). The Internet service provider is connected to an Internet hub (not shown), which is connected to other Internet service providers and/or other hubs. Virtually any type of device can act as the user's interface 110 to host 100 such as a Personal Computer (PC), a workstation, a Personal Digital Assistant (PDA), a web enabled cellular telephone, a web enabled television or any other web enabled device for example.

Prior to accessing the full range of services of the present invention offered on host computer web site 100, each user 110 registers with the administrator of the host computer 100. The administrator recognizes registrations from individual and company users. Registrants' applications may be verified manually, offline. Pending verification of the registrant's application, the applicant may access only the transactions ceded specifically to the user, as further described below. If verified and approved, a registrant's record is updated so that the registered user may enjoy full exchange privileges. The administrator may program the host computer 100 to allow registered users to receive e-mail notifications from the host computer 100 regarding exchange updates and newly posted offers.

Once registered, a user 110 establishes communication with the host computer 100 via conventional Internet access. The user 110 establishes communication with the user's Internet service provider and provides the user's user name and password, as is conventionally known. Upon successfully entering the appropriate user name and password combination, the Internet service provider recognizes the user 110 as a valid user. Using a browser, such as Netscape™ or Microsoft Internet Explorer™, the user 110 accesses the web site of the host computer 100 by penetrating another level of network firewalls following authentication by the host computer 100. Authentication by the host computer 100 may be obtained by any conventional means, such as successful entry of another user name-password combination.

Once logged into the web site, the host computer 100 permits the user 110 to access authorized features and information of the site and engage in transactions with other users 110. The host computer administrator may establish parameters for a user's hierarchy within the system 100 to establish which users 110 may access which portions the web site or engage in which administrative functions. The user may access the web site and transact business with other users so long as the user remains in good standing according to the web site rules.

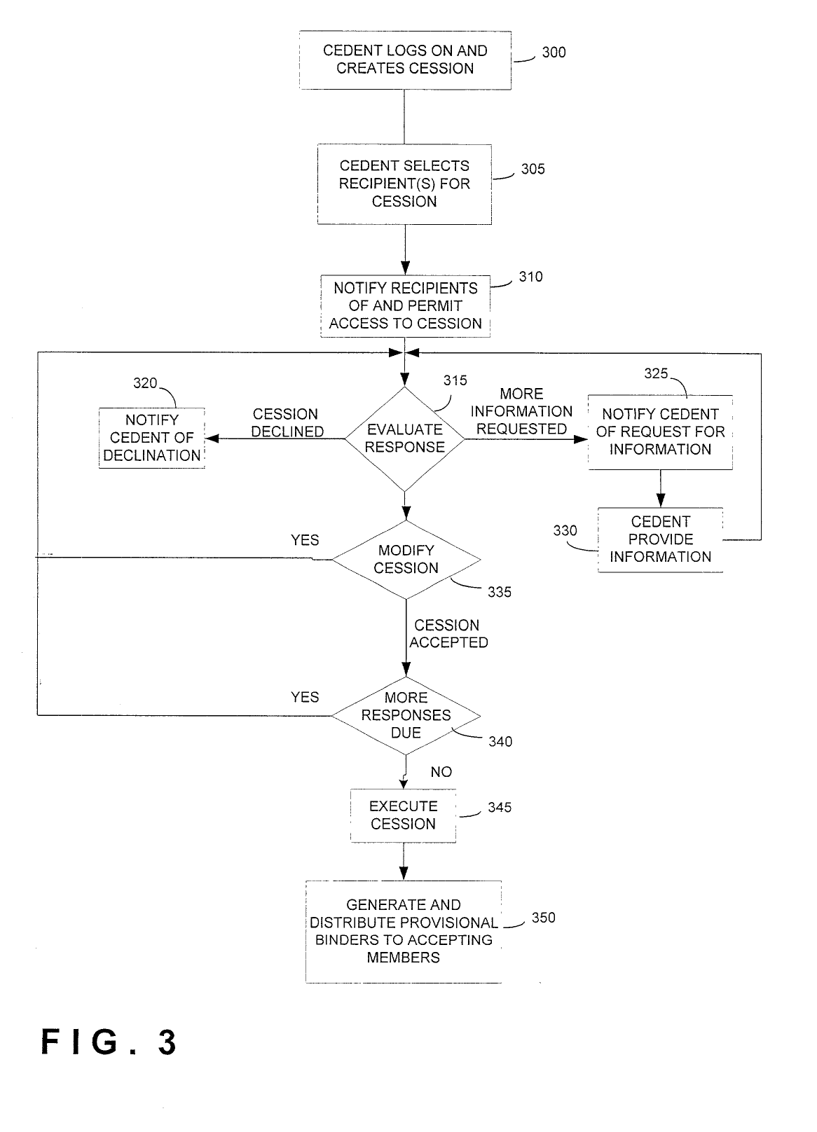

FIG. 3 illustrates the method executed on system 100 for performing the main function of the present invention—facilitating insurance and re-insurance transactions. In step 300, one of the users 110 (the ceding party) logs onto the host computer 100 and creates a cession that he/she desires to be fulfilled. Again, the ceding party is typically an insurance broker, an individual or an insurance company and the cession represents a risk for which the ceding party desired insurance or reinsurance coverage.

The process of creating a cession in step involves the user 110 choosing the specific line of insurance for ceding or creating. Imbedded web site programing within host 100 provides users with templates of placement slips or sheets, which users 110 complete with pertinent information on the risks intended for cession. The templates provide conventional drop down menus for selecting attributes specific to particular lines of insurance coverages. Should no selectable menu item suit a user's needs, the user 110 may input details, including the types of the perils involved, with a template wizard. The template wizard is a software application that allows the user 110 to create a customized cession by prompting the user 110 for specific information about the risk and desired coverage that is then included in the cession generated by the wizard.

Risks come in many forms, such as home, automotive, health, business and so forth. Each type of risk has attributes that may be unique or not applicable to other risks. Thus, each type of risk may be described with a format that is different from the formats of other risks. Accordingly, the host computer 100 is configured to accept multiple formats for each type of cession. The web site-provided templates also permit users to include attachments in different formats, such as text files and image files. This allows users to provide information to receiving parties about offered risks in a convenient and efficient manner.

Once created, system 100 stores the submitted cession in a database for future access as described below. In step 305, the ceding party selects one or more potential insurers that he or she desires to review the cession. To facilitate choosing parties to form a panel of receiving parties, host 100 allows the cedent to search the host computer member data base by last name, first name, company name, country or other user-specified criteria. In a preferred embodiment, the cedent selects the recipients from a drop down list of members provided on the web site. The member menus may list members by capacity, types of risks handled or other user-directed criteria.

When the web site displays a member, a user 110 may obtain more information about the member by training the cursor over the member's name. Host 100 provides the user with the member's corresponding company information and photograph, if available. Users 110 may develop groups of “favorite” members for ready selection. Selecting a “favorite” group may be used as a shortcut for forming a panel to which a cession is posted. A user 110 may form an entire panel of receiving parties simply by indicating, or clicking, on the name of a previously created “favorite” list.

The host web site also permits users 110 to select panel members based on capacity market space. To this end, web site programing allows a user 110 to post the user's capacities to advise others of same. Informing others of the user's capacity provides an opportunity for initiating business with other users 110 that otherwise may not interact.

In step 310, host 100 notifies the selected recipients, the panel members, of the posting of the cession and permits these intended recipients to access the cession. In a preferred embodiment, the notification to the panel members is by e-mail. Security software in host 100 permits only panel members to access the stored cession and no other users 110 may access the cession, unless authorized by the cedant. Each panel member then evaluates the posted cession. Each panel member may respond by accepting the offer, declining the offer or requesting additional information about the offer. In step 315, the response or responses from the panel members are evaluated.

If the particular response indicates that the panel member has declined the cession, the cedant is notified in step 320. If the panel member, after evaluating the cession, still requires more information, the panel member inputs the request for more information into host 100. The host 100 then, in step 325, notifies the cedant of the request and passes on the request to the cedant. In step 330, the cedant provides, preferably through system 100, the additional information. The passage of the additional information can also be accomplished offline, for example, through a phone call between the cedant and the panel member. The cedant might also determine that the other panel members would benefit from the additional information. If this is the case, then system 100 passes on the additional information to each of the panel members at the direction of the cedant.

The host computer 100 permits the cedant to respond and engage in more confidential information exchanges with the panel members. For example, the cedant may respond with a private email or through a “chat room” function administered by the host computer. “Chat rooms” are well known, thus are not described herein.

As a result of the additional information requested or other comments by the panel members, the cedant may choose or have to modify the terms of the cession. If this occurs (Yes, out of step 335) the panel members are requested to again evaluate the cession. If a panel member has already accepted the cession, that panel member's acceptance is voided and the panel member has to re-evaluate the cession and again provide a acceptance, a declination or a request for additional information. Similarly, over time, the specifics of a risk may change or additional specifics may become known. Accordingly, the host computer 100 permits the cedant to update a posted cession in order to incorporate the changes and additions. A cedant also may cancel or void a posted cession.

Cessions that have been posted are either “firm” or “conditional.” The host computer 100 allows a cedant to change any or all of the terms and conditions of a conditional cession. Each time the cedant changes a cession, the host computer 100 generates a message advising all of the panel members of the change. Once the cedant determines that all the terms and conditions are acceptable to the panel members, the cedant changes the status of the cession to “firm”. While the offer (cession) is conditional, only the cedant knows the total amounts of acceptances that have been made and by which receiving party. In one embodiment, the cedant can keep track of the acceptances through the use of a “notepad” that the cedant may click on to record whatever information and/or details he/she wants regarding the offer.

However, once the offer has been made firm, the cedant and the receiving parties may view the status, the percentage of acceptances and totals of everyone. This information is available on a specific screen [resented by host 100 related to the cession. When the cedant executes the offer (as further described below), system 100 automatically computes all the acceptances and adds that to the cedant's gross retention. Should it fall below 100%, system 100 alerts the cedant that the offer is undersubscribed. The cedant then has the option to continue executing the Offer, which leads system 100 to automatically add the shortfall in acceptances to the cedant's own gross retention. Alternatively, the cedant may choose to resend the offer to a new set of receiving parties by either sending them email notifications of the offer or by choosing members from the list of members maintained by system 100 as described above.

If the panel member chooses to accept a share of the cession, the panel member indicates its interest to the cedant and the percentage of acceptance they wish to undertake, together with an acceptance code. Host 100 registers the acceptance code which is unique to a panel member (for that cession) and serves as the identifier for the panel member's company's transaction processing. A single cession contract is almost always split among receiving parties, that is, each panel member that indicates acceptance to a cession accepts a percentage of the total cession being offered. When the cedant is initially creating the cession (offer), part of the information required in the placement sheet that the cedant fills out when posting an Offer are: the percentage of the offer that is being offered to a recipient, the percentage of minimum acceptance that the recipient can make, and the percentage of maximum acceptance for that member. Each panel member may opt to accept only some of the perils/conditions in a host of perils/conditions being offered in a single cession. Typically, this is accomplished through a communication between the cedant and the receiving party. One method by which this will be effected is through a “chat box”The receiving party, after viewing the terms and conditions posted by the cedant clicks on a “message” button on his/her screen presented by the host 100 and types in a “message” with his/her desired or proposed terms and conditions of acceptance to the cedant.

Until the ceding party closes the offer, when the risk has been fully placed, panel members who have not accepted or declined the offer may continue to evaluate same. The ceding party notes acceptance codes transmitted by panel members that accept the risk. In step 340, it is determined whether the are any outstanding responses from panel members. The offer may be closed, at the discretion of the cedant, even if all of the panel members have not responded. If all of the panels members have responded or if the risk has been fully placed, the ceding party closes and executes the transaction in step 345. Executing the transaction means that the cedant has successfully placed the entire risk and that he now wishes to consummate the transaction.

Before the cedant actually executes the cession, host computer web site programming permits the cedant to review the cession one final time. If the transaction is acceptable, the user executes the cession and the host computer 100 generates a unique transaction code for the executed session. The host computer 100 notifies all of the parties involved when a cession is executed. Thereafter, the placement is closed from further updates.

Once the ceding party executes the transaction, host 100 automatically generates the provisional binders required by the acceptances of the cession in step 350. These provisional binders are automatically distributed to the panel members that accepted the cession. Host computer 100 allows the parties to a transaction to view, print and download copies of the related provisional binders for processing within the party's company systems. Host 100 further registers the executed transaction and archives all information related to the transaction, including communications related to the offer conducted through the web site.

While logged into the present web site, users may engage in any of several options, posting and updating cessions; viewing posted cessions; “chatting” with counter parties; accepting, declining canceling and voiding cessions; forwarding and delegating cessions to other registered users within the users' organizations; viewing, printing and downloading provisional binders; viewing, printing and download reports; requesting special reports; and administering the users' accounts.

In addition to the normal transaction process described above, the host web site 100 also provides a “public space” where users 110 may post and view non-designated placements or cessions. In this manner, a user 110 may post a risk to the public space for all exchange members to view, without selecting particular members for evaluation of the cession. Host 100 further allows users 110 to view placements by line or by other conditions. For example, users may view placements by capacity, hazard, cedant or other criteria.

When the cedant posts a cession to specific other users 110 as described above, the cedant always knows the identities of the receiving parties to whom a risk is ceded. On the other hand, the receiving parties may not know the identities of the other members who have been selected to evaluate a cession. Host 110 allows a receiving party to reveal it's identity to other receiving parties. If a receiving party chooses not to reveal it's identity, host 100 identifies the receiving party as “anonymous.”

Should a cedant want to send a cession to a non-exchange member, the cedant may input a receiving party's email address to which the host computer sends an email notice to the receiving party with the cession URL. The non-exchange party accesses the cession by executing, or clicking, the given URL. Executing the URL launches the exchange registration page with which the non-exchange party must register before accessing the cession.

Should a cession be under-subscribed, based on the cedant-entered parameters during cession creation, the host computer 100 recognizes this condition and notifies the cedant of such. The cedant then may add more panel members to which the cession will be offered, as described above. A cedant also may override the system and execute the transaction. In response, the host computer re-calculates and increases the Cedant's gross retention vis-a-vis the total acceptances by the panel members.

Host system 100 also contains a feature known as a Renewal Alert. This feature provides an alert or reminder notification to a cedant that a transaction he/she previously executed is about to expire. Typically, insurance or reinsurance contracts have a term of a year. The cedant has the ability to choose the number of days, for example between 45-60 days, before the policy expires when the system 100 notifies the cedant of the expiring contract. At the time of the reminder or alert, the cedant will be presented with a copy of the transaction as in force. The cedant then has the ability to make changes and/or updates to the terms and conditions and generate a new cession (or a renewal) based on the expiring cession. The cedant can retain the same subscribing members, as well as adding or deleting members before ceding the new (or renewal) Offer to a panel.

Although the present invention has been described in relation to particular embodiments thereof, many other variations and modifications and other uses will become apparent to those skilled in the art. The present invention is not limited by the specific disclosure herein, but only by the appended claims.

We claim:

1. A method of facilitating insurance and reinsurance transactions, the method comprising:
accepting a cession from a first user;
posting the cession on a host computer system, the host computer system hosting an Internet website;
receiving from the first user an identification of at least one second user designated to receive the cession;
providing the at least one second user with access, through the Internet, to the Internet website hosted by the host computer system;
providing the at least one second user with access to the cession;
receiving a response from the at least one second user, the response including one of a declination of the cession, an acceptance of the cession, and a request for additional information about the cession; and
executing the cession if the response from the at least one second user is the acceptance of the cession.

2. The method of claim 1, further comprising providing additional information about the cession if the response from the at least one second user is the request for additional information about the cession.

3. The method of claim 2, wherein the step of providing the additional information further comprises providing a chat room facility in which the first user and the at least one second user can exchange the additional information.

4. The method of claim 2, wherein the step of providing the additional information further comprises providing an email facility by which the first user and the at least one second user can exchange the additional information.

5. The method of claim 1, further comprising archiving all information and communications related to the cession.

6. The method of claim 1, further comprising reminding the cedant prior to a time when the executed cession is to expire.

7. The method of claim 6, further comprising enabling the cedant to choose when said reminding step is to occur.

8. The method of claim 1, further comprising generating a provisional binder related to the cession after the execution step.

9. The method of claim 8, further comprising transmitting the provisional binder to the first user and the at least one second user.

10. The method of claim 8, further comprising archiving the provisional binder.

11. The method of claim 1, further comprising, transmitting an acceptance notification to the at least one second user if the response from the at least one second user was the acceptance of the cession.

12. The method of claim 1, further comprising providing the first user with a list of identifications from which the first user may select the second user.

13. A method of facilitating insurance and reinsurance transactions, the method comprising:
accepting a cession from a first user;
posting the cession on a host computer system, the host computer system hosting an Internet website;
receiving from the first user an identification of a plurality of second users designated to receive the cession;
providing the second users with access, through the Internet, to the Internet website hosted by the host computer system;
providing the second users with access to the cession;
receiving a response from the at least one of the second users, the response including one of a declination of the cession, an acceptance of the cession, and a request for additional information about the cession; and
executing the cession if the response from the at least one second user is the acceptance of the cession.

14. The method of claim 13, further comprising:
receiving responses from additional ones of the second users, the responses including one of the declination of the cession, the acceptance of the cession, and the request for additional information about the cession; and
executing the cession if the response from either the at least one second user or the additional ones of the second users is the acceptance of the cession.

15. The method of claim 13, further comprising informing the first and second users of a transaction related to the cession.

16. The method of claim 13, further comprising receiving responses from additional ones of the second users, each of the responses from the additional ones of the second users being an acceptance of a percentage of the cession.

17. A system for facilitating insurance and reinsurance transactions, the system comprising:
an interface to the Internet;
host computer system coupled to the interface;
an Internet website hosted by the host computer system, wherein users access the Internet website on the host computer through the interface;
a memory coupled to the host computer system; and
the Internet website operable to:
receive a cession from a first user,
store the cession in the memory,
receive from the first user an identification of at least one second user designated to receive the cession,
provide the at least one second user with access to the cession stored in the memory,
receive a response from the at least one second user, the response including one of a declination of the cession, an acceptance of the cession, and a request for additional information about the cession, and
execute the cession if the response from the at least one second user is the acceptance of the cession.

18. The system of claim 17, wherein the host computer system comprises chat room facility in which the first user and the at least one second user can exchange additional information related to the cession.

19. The system of claim 17, wherein the host computer system comprises an email facility by which the first user and the at least one second user can exchange additional information related to the cession.

20. The system of claim 17, wherein the Internet website is further operable to archive in the memory all information and communications related to the cession.

21. The system of claim 17, wherein the Internet website is further operable to generate a provisional binder related to the cession after the execution of the cession.

22. The system of claim 21, wherein the interface is used to transmit the provisional binder to the first user and the at least one second user.

23. The system of claim 21, where in the provisional binder is archived in the memory.

24. The system of claim 17, f wherein the interface is used to transmit an acceptance notification to the at least one second user if the response from the at least one second user was the acceptance of the cession.

25. The system of claim 17, wherein the memory contains a list of identifications from which the first user may select the second user.
